(19) United States
(12) Patent Application Publication
(10) Pub. No.: US 2016/0182740 A1
(43) Pub. Date: Jun. 23, 2016

(54) Portable Device with Visual Signal Notice Module

(71) Applicants: Yi-Chuan Cheng, Yongjing Township (TW); Horng-Huei TSENG, Hsinchu (TW)

(72) Inventors: Yi-Chuan Cheng, Yongjing Township (TW); Horng-Huei TSENG, Hsinchu (TW)

(21) Appl. No.: 14/578,341

(22) Filed: Dec. 20, 2014

(51) Int. Cl. H04M 19/04; H04M 1/725

(52) U.S. Cl. CPC H04M 19/048; H04M 1/72583; H04M 1/72597

(57) ABSTRACT

A portable device with visual signal notice module is proposed. It allows the image indicating type of an incoming signal to notice its corresponding incoming signal for corresponding icon to a user of the portable device in a sleep mode by a visual signal notice module. Each of icons is associated with a specified function and can be touched by a user for further operating.

### TECHNICAL FIELD

The present invention relates to a portable device, and more particularly, to a portable device with a visual signal notice module for noticing an incoming signal of the portable device in a sleep mode to a user.

### BACKGROUND OF RELATED ART

Because of the development of the information technology (IT), the information could be exchanged with higher capacity and faster speed. Internet is designed as an open structure to exchange information freely without restriction. The third generation mobile phone standard allows the user access video communication through air. Thus, certain communication service requiring real time information exchange, such as viewing live video, has become feasible through mobile phone communication network or Internet. Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. In pace with the development of information and computer technology, the electronic products grow rapidly with the trend of small size, multifunction and high operation speed. Based on the development of cellular integration technology, communication systems have also been introduced to allow users obtain information more convenient. Thus, the business accompanied with the communication device flourish as well due to the development of the communication technology. The internet and communication service providers also offer business services to assist clients to transfer information or extend the market. The cellular manufactures have to release new models with different appearances, function and styles more frequently so as to attract the attention of the buyer and occupy a favorable marketing share. Communication services providers or information services providers also have to provide diverse, comprehensive and latest information to clients. However, signals received by the communication module are not display on the screen in silent mode. Thus, the present invention is introduced to overcome aforementioned shortcoming

### SUMMARY

The present application allows images for indicating type of the incoming signal for corresponding icon that are easily availably noticing an incoming signal to a user of a portable device in a sleep mode by a visual signal notice module.

According to the invention, icons are not displayed on the touch screen of a portable device in a silent mode. Each of the icons is associated with a specified function and can be touched by a user for further operating. As user touches the icon, the portable device can receive information representing the icon and such information can be displayed in association with the icon. If the client (sleep) mode is achieved, then a visual signal notice module is launched. The information can include an e-mail, a phone call, a short message service message, Line (Instant Message) message or facebook (social utility) message etc.

According to one aspect of the invention, a portable device comprises a control unit, and a display coupled to the control unit. A touch screen is capable of supporting multiple functional icons. A visual signal notice module is responsive to an incoming signal from another portable device to allow a specified image indicating type of the incoming signal displayed on the touch screen when the portable device is in a sleep mode.

According to another aspect of the invention, the portable device further comprises a memory coupled to the control unit for storing the visual signal notice module. The type of the incoming signal is a signal of phone call, short message service, e-mail, Line instant message or facebook message. The portable device further comprises a wireless data transferring module, an image capture module coupled to the control unit.

According to one aspect of the invention, the specified image indicating type of the incoming signal is capable of flashing. An interval of the flashing can be controlled by the control unit.

The foregoing and other objects, features, and advantages of the invention will become more apparent from the following detailed description, which proceeds with reference to the accompanying figures.

### BRIEF DESCRIPTION OF THE DRAWINGS

The components, characteristics and advantages of the present invention may be understood by the detailed descriptions of the preferred embodiments outlined in the specification and the drawings attached:

FIG. 1 is an example of a portable device of the present invention;

FIG. 2 illustrates input devices/output devices of the FIG. 1;

FIG. 3 illustrates specified icons on home screen according to one embodiment of the present invention;

FIG. 4 illustrates a visual signal notice module stored in memory according to one embodiment of the present invention;

FIG. 5 illustrates a block diagram showing some components of the portable device according to one embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

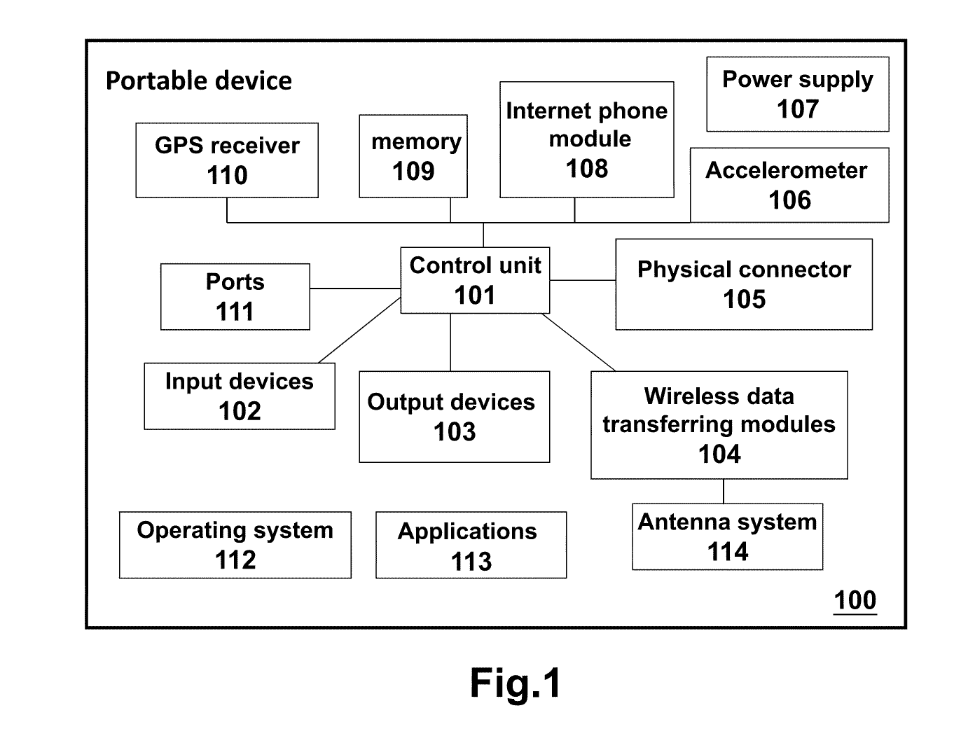

FIG. 1 is a functional diagram depicting an exemplary portable device 100 including a variety of optional hardware and software components. Any components in the mobile device can communicate with any other component, although not all connections are shown, for ease of illustration. The portable device 100 can be any of a variety of computing devices (e.g., cell phone, smart phone, Personal Digital Assistant (PDA), tablet etc.) and can allow wireless two-way communications with one or more mobile communications networks, such as a cellular or satellite network.

The illustrated portable device 100 can include a controller (control IC) or processor 101 (e.g., signal processor, microprocessor, ASIC, or other control and processing logic circuitry) for performing such tasks as signal coding, data processing, input/output processing, power control, and/or other functions. An operating system 112 can control the allocation and usage of the components and support for one or more application programs 113. The application programs 113 can include common mobile computing applications (e.g., email applications, calendars, contact managers, web browsers, messaging applications), or any other computing application.

The illustrated portable device 100 can include memory 109 which can include non-removable memory and/or removable memory. The non-removable memory can include RAM, ROM, flash memory, a hard disk, or other well-known memory storage technologies. The removable memory can include flash memory or a Subscriber Identity Module (SIM) card, which is well known in GSM communication systems, or other well-known memory storage technologies, such as “smart cards”. The memory can be used for storing data and/or code for running the operating system 112 and the applications 113. Example data can include web pages, text, images, sound files, video data, or other data sets to be sent to and/or received from one or more network servers or other devices via one or more wired or wireless networks. The memory can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

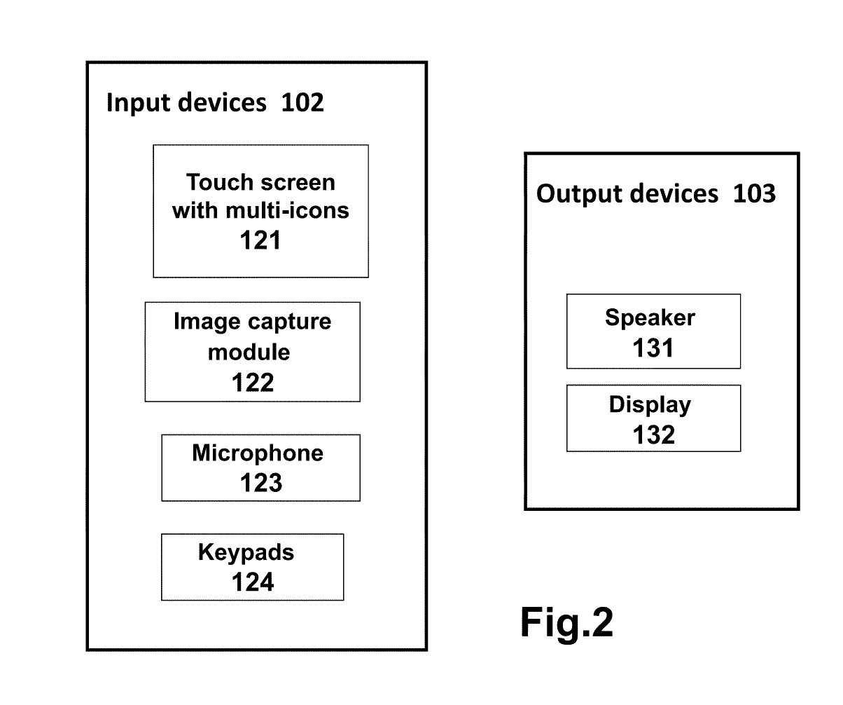

The portable device 100 can support one or more input devices 102, such as a touch screen 121, camera 122, microphone 123 and keypads 124, and one or more output devices 103, such as a speaker 131 and a display 132, shown in FIG. 2. Some devices can serve more than one input/output function. For example, touch screen 121 and display 132 can be combined in a single input/output device. The touch screen 121 can support multiple functional icons. The icons can be displayed on a home (touch) screen, which is typically the screen displayed when the portable device is powered on. The home screen is the base screen that generally cannot be further minimized and that contains icons representing applications. As further described below, each icon is represented by an image based on its respective application.

The portable terminal or device 100 includes at least one wireless data transferring modules 104. The first wireless data transferring module 104 could be video RF module to transmit or receive mobile phone signal and it is well known in the art. As know in the art, the RF unit is coupled to an antenna system 114. The RF module may include base band processor and so on. This antenna is connected to a transceiver, which is used to receive and transmit signal. The first wireless data transferring modules 104 is compatible to the mobile phone protocol such as W-CDMA CDMA2000 CDMA2001 TD-CDMA TD-SCDMA UWC-136 DECT 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 131 including a loudspeaker and a microphone. The module 104 can be formed by separated module (chip) or integrated chip. A wireless data transferring module 104 can be coupled to an antenna and can support two-way communications between the processor 101 and external devices, as is well understood in the art.

The device 100 further includes the second wireless data transferring module 104. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet phone module 130 are coupled to the central control unit 101 to allow transmit and receive the audio, video or both type signal to/from the internet network through the wireless local area wireless transmission module. Internet phone module 108 at least meets the standard of terminal-terminal Voice Over Internet Protocol (VoIP). One of the examples is Skype compatible protocol. By using of the Internet phone module 130 and the wireless local area network module 200B, the user may portably, synchronously transmit and receive the vocal, video or both signal through the internet by using the internet (software) phone module 130. The present invention defines a hand-held device having VoIP phone module and wireless WiFi or WiMax network linking module coupled to the VoIP phone module to allow the user to make a wireless terminal-terminal VoIP phone without power on the PC. The voice over internet protocol (VoIP) phone module is used to encode or convert the voice signal into VoIP protocol within the portable communication device before transmitting the signal, followed by programming the signal into WiFi or WiMax format in order to transmit the voice signal through the wireless network, especially, the Skype phone.

The portable device 100 can further include at least one input/output port 111, a power supply 107, a satellite navigation system receiver 110, such as a Global Positioning System (GPS) receiver, an accelerometer 106, and/or a physical connector 105, which can be a USB port, IEEE 1394 (FireWire) port, and/or RS-232 port. The illustrated components are not required or all-inclusive, as any components can deleted and other components can be added. For example, the device 100 may include DSP, CODEC (not shown) and A/D converter as well.

An image capturing module 122 is required and coupled to the central control unit 101 to catch the video image if the user would like to conduct the real-time video transmission. The image capturing module 122 could be digital still camera, digital video camera. Therefore, the real-time portable conference is possible. In another embodiment, the one difference is that the device may omit the RF module. If the device 100 includes 3G or higher level RF module, the user may transmit the video phone through the air. Therefore, the user may select one of the schemes to make a video call through internet or air depending on the user demand If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams.

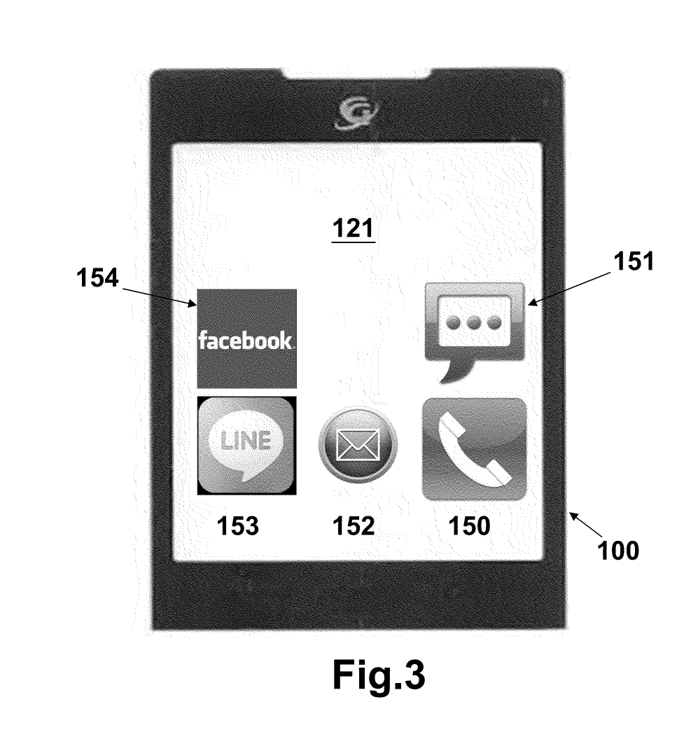

As noted above, the touch screen 121 can support multiple functional icons 150 to 154, shown in FIG. 3. The icons can be displayed on a touch (home) screen, which is typically the screen displayed when the portable device is powered on. The icons are not displayed on the home screen when the portable device is in the silent (sleep) mode. The home screen is the base screen and contains icons representing applications. Each icon is represented by an image based on its respective application. For example, an image of the icon 150 represents a phone call; an image of the icon 151 represents a short message service; an image of the icon 152 represents an e-mail; an image of the icon 153 represents Line (Instant Message); an image of the icon 154 represents a facebook (social utility).

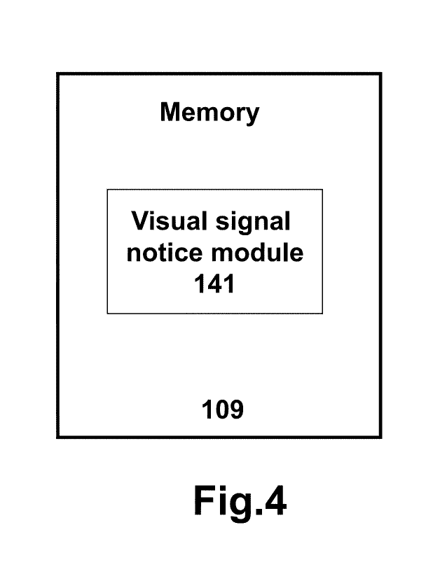

The portable device 100 includes a visual signal notice module 141 for noticing an incoming signal to a user in a silent (sleep) mode. In one embodiment, the visual signal notice module 141 is stored in the memory 109, shown in FIG. 4.

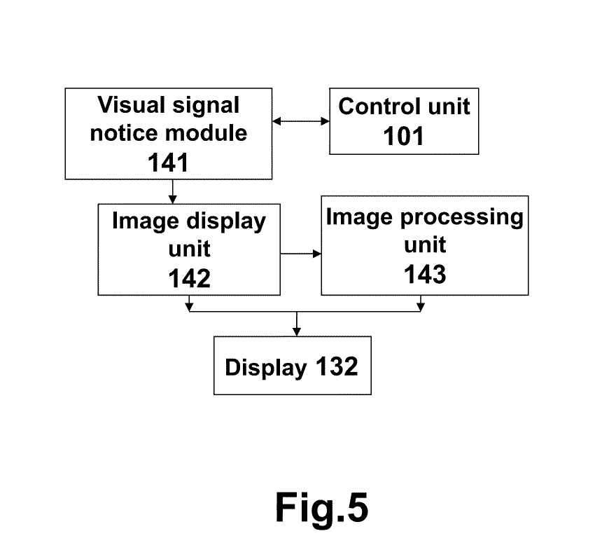

Please turning to FIG. 5, the present invention also includes a visual signal notice module 141 coupled to the control unit 101 as shown in FIG. 5. The visual signal notice module 141 is coupled to an image display unit 142. As an incoming signal transmitted from the external portable device is sending to the portable device 100 in a silent (sleep) mode, the visual signal notice module 141 is then noticing to the image display unit 142 for showing the specified image indicating type of the incoming signal on the touch screen 121 of the display 132. The specified image may indicate its corresponding functional icon. Thus, the specified image indicates a signal of phone call, short message service, e-mail, Line (Instant Message) message or facebook (social utility) message. In one embodiment, the specified image indicating type of the incoming signal may be flashing, and brightness of the image and an interval of flashing can be controlled by the control unit 101.

In general, the icons are not displayed on the home screen when the portable device is in the silent (sleep) mode. When the portable device 100 in the silent (sleep) mode is receiving the transmitted signal from the external portable device, only the specified image indicating type of the incoming signal is shown on the home screen 121 of the display 132 based-on the noticing signal of the visual signal notice module 141. That is, only the specified image indicating type of the incoming signal is showing on the home screen 121 of the display 132. In one embodiment, the specified image indicating type of the incoming signal can be processed by the image processing unit 143 before sending the image data signals to the display 132. In one embodiment, the image processing unit 143 maybe employed to adjust the specified image before displaying. Thus, the visual signal notice module 141 may allow the control unit to process the incoming signal from the external portable device, and notice the user of the portable device 100 via showing the specified image indicating type of the incoming signal on the home screen 121 of the display 132.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

1. A portable device, comprising:
a control unit, a display coupled to said control unit;
a touch screen capable of supporting multiple functional icons; and
a visual signal notice module coupled to said control unit and incorporated into said portable device, wherein said visual signal notice module is initiated when an incoming signal is sent from a second portable device to said portable device in a sleep mode, to allow a corresponding functional icon of said incoming signal displaying on said touch screen from non-display status without audio noticing, wherein said multiple functional icons are not displayed on said touch screen when said portable device is in said sleep mode.

2. The portable device as set forth in claim 1, further includes a memory coupled to said control unit for storing said visual signal notice module.

3. The portable device as set forth in claim 1, wherein said type of said incoming signal is a signal of phone call, short message service, e-mail, or instant message.

4. The portable device as set forth in claim 1, further include a wireless data transferring module coupled to said control unit.

5. The portable device as set forth in claim 1, further comprising a network phone module coupled to said control unit.

6. The portable device as set forth in claim 1, further includes an image capture module coupled to said control unit.

7. The portable device as set forth in claim 1, further comprising an image display unit coupled to said visual signal notice module and said display.

8. The portable device as set forth in claim 1, wherein said specified image indicating type of the incoming signal is capable of flashing.

9. The portable device as set forth in claim 8, wherein an interval of said flashing can be controlled by said control unit.

10. The portable device as set forth in claim 1, wherein said portable device is a cell phone, a smart phone, a Personal Digital Assistant or a tablet.

11. The portable device as set forth in claim 8, wherein said type of said incoming signal is a signal of phone call, short message service, e-mail, or instant message.

12. The portable device as set forth in claim 11, further includes a memory coupled to said control unit for storing said visual signal notice module.

13. The portable device as set forth in claim 11, further include a wireless data transferring module coupled to said control unit.

14. The portable device as set forth in claim 11, further comprising a network phone module coupled to said control unit.

15. The portable device as set forth in claim 11, further includes an image capture module coupled to said control unit.

16. The portable device as set forth in claim 11, further comprising an image display unit coupled to said visual signal notice module and said display.

17. The portable device as set forth in claim 16, wherein an interval of said flashing can be controlled by said control unit.

18. The portable device as set forth in claim 11, wherein said portable device is a cell phone, a smart phone, a Personal Digital Assistant or a tablet.
